(19) United States
(12) Patent Application Publication
(10) Pub. No.: US 2025/0026427 A1
(43) Pub. Date: Jan. 23, 2025

(54) VARIABLE ANGLE WING STRUCTURE FOR VEHICLES

(71) Applicant: Studio 1986 Inc., Walnut, CA (US)

(72) Inventors: Vincent Wei Lee, Walnut, CA (US); Ching-Min Shu, New Taipei City (TW)

(73) Assignee: Studio 1986 Inc., Walnut, CA (US)

(21) Appl. No.: 18/224,548

(22) Filed: Jul. 20, 2023

(51) Int. Cl. B62J 17/00; B62D 37/02

(52) U.S. Cl. CPC B62J 17/00; B62D 37/02

(57) ABSTRACT

The present invention provides variable angle wing structure for vehicles installed on the outer side of the handlebar of a motorcycle. It can automatically adjust the angle according to the vehicle speed to provide optimal downforce and assist in vehicle travel. The present structure includes a fixed seat, a pivot shaft, a wind deflector mechanism, a control device, a drive unit, and a vehicle dynamic sensor. Through the control device, the information detected by the vehicle speed sensor is transmitted to the control device, and the inclination angle of the wind deflector is controlled based on the set value to improve driving safety and stability. The variable-angle wind deflector structure of the present invention is applied to motorcycles and compared to the existing fixed-angle wind deflector, it can effectively improve stability during driving, providing a safer driving experience.

### BACKGROUND OF THE INVENTION

### 1. Field of the Invention

The present invention relates to the technical field of vehicle fixed wing, in particular a variable-angle vehicle fixed wind wing structure that has a multi-piece interactive application and automatic angle adjustment function.

### 2. Description of the Prior Art

In earlier motorcycles, fixed wind wings were not equipped, making it easy to encounter instability at high speeds. In order to solve this problem, people began to install single-wing fixed wind wings on the motorcycle body to improve the safety and stability of motorcycle driving. Later, with the development of motorcycles, the design of fixed wind wings has also been further improved. One important advancement is the introduction of various fixed wind wing shapes, such as bird-shaped and airplane-shaped, to improve the efficiency of downforce.

At the same time, the materials and manufacturing processes of fixed wind wings have also been improved. Modern fixed wind wings usually use lightweight materials such as carbon fiber and glass fiber to reduce their weight and wind resistance, further improving the driving performance of motorcycles. In motorcycle dynamics, the fixed wind wing is an important component, whose main function is to generate downforce at high speeds to improve the stability and safety of motorcycles. Traditional fixed wind wings are usually fixed, meaning that once they are installed on the motorcycle, their angle cannot be adjusted. However, at different speeds, the size of the generated downforce also varies, which can have a negative impact on the safety and stability of motorcycle driving.

Therefore, there is a need for a wind wing design that can automatically adjust its angle according to the motorcycle speed to improve its safety and stability. This new type of wind wing needs to meet the following conditions:
It can automatically adjust its angle according to the motorcycle speed to improve the efficiency of generating downforce.
The multi-blade wind wing structure can produce better downforce and driving stability than a single-blade wind wing by utilizing the different wind field effects generated by the different angles between the blades.

Therefore, we propose an invention of a variable-angle vehicle fixed wind wing structure that can automatically adjust its angle according to the motorcycle speed to improve its efficiency and meet the application needs in actual racing fields.

### SUMMARY OF THE INVENTION

In view of the above, the present invention provides a variable angle wing structure for vehicles to overcome the aforementioned problems and meet the requirements of improving the wind deflector efficiency and satisfying the application needs of general riding and racing.

To achieve the above purposes, the present invention provides the following technical solution:

The present invention provides a variable angle vehicle wind deflector structure, which is installed on the outside of the motorcycle's handlebar and can automatically switch angles according to the vehicle speed to improve the safety and stability of the motorcycle during travel. Specifically, the wind deflector structure includes a bracket, a rotatable wing, a speed sensor, and a control unit. The bracket is installed on the outside of the motorcycle's handlebar, and the wing is rotatably installed on the bracket. The speed sensor is installed on the motorcycle to sense the travel speed of the vehicle. The control unit is connected to the wing and the speed sensor to adjust the angle of the wing according to the vehicle speed.

The fixed-wing structure of the present invention further includes the following main components:
An adjustment mechanism: used to adjust the angle of the fixed-wing, which is controlled by an electric motor and can be adjusted automatically or manually;
A fixed wind wing mechanism: fixed on the adjustment mechanism, and has at least one variable-angle fixed-wing and one fixed-angle fixed-wing. The variable-angle fixed-wing can automatically switch angles according to the speed of the vehicle; and
A power system: provides power to the adjustment mechanism.

The adjustment mechanism can automatically adjust the angle of the fixed-wing according to different vehicle speeds to achieve optimal wind resistance effects. When the vehicle speed is faster, the adjustment mechanism will automatically adjust the angle of the fixed-wing to form a larger wind-blocking area, increase the downward pressure, and make the vehicle more stable. When the vehicle speed slows down, the adjustment mechanism will automatically adjust the angle of the fixed-wing to form a smaller wind-blocking area, reduce wind resistance, and improve fuel efficiency.

In addition, the fixed wind wing can be made of various materials such as fiberglass, carbon fiber, and aluminum alloy. The appearance of the fixed wind wing can be painted or covered with tape to enhance the aesthetics of the motorcycle. Moreover, the shape of the fixed wind wing can also be designed differently, such as a raised type, a flat type, a curved type, etc., to adapt to different driving situations.

Furthermore, the power supply system can use the motorcycle battery or an external power supply to provide power to the adjustment mechanism.

In summary, through the present invention, a variable-angle vehicle fixed wind wing structure is provided, which can automatically switch angles according to the vehicle speed to achieve the best wind resistance effect, improve the stability and fuel efficiency of the vehicle, and has practicality and innovation.

When in use, when the vehicle's speed is below a certain threshold, the control unit will automatically adjust the angle of the wing to a smaller angle to reduce the effectiveness of downforce. When the vehicle's speed is above the threshold, the control unit will automatically adjust the angle of the wing to a larger angle to increase downforce and improve the vehicle's driving stability.

In addition, the fixed wind wing structure has the following advantages:
The variable-angle design allows the wind wing to be adjusted according to the vehicle's speed to achieve the best effect.
The design installed on the outside of the dragon head does not affect the vehicle's air resistance and can effectively improve the vehicle's driving stability.
The control unit adopts an intelligent design and can automatically adjust the wind wing angle according to real-time driving conditions, further improving driving safety and stability.
By setting a fixed wind wing structure (support frame) and a movable wind wing, a whole wind field effect can be generated to further enhance the downforce effect that the fixed wind wing of the present invention can produce.

### BRIEF DESCRIPTION OF THE DRAWINGS

FIG. 1 is a perspective view of the variable-angle vehicle fixed wind wing structure installed on the motorcycle shell;

FIG. 2 is a partially exploded perspective view of FIG. 1;

FIG. 3 is a sectional view of the variable-angle vehicle fixed wind wing structure of the present invention;

FIG. 4 is another sectional view of the variable-angle vehicle fixed wind wing structure of the present invention;

FIG. 5 is a partial modular block diagram of the variable-angle vehicle fixed wind wing structure of the present invention; and

FIG. 6 is a schematic diagram showing the angle change of the fixed wind wing structure of the present invention.

### DETAILED DESCRIPTION OF THE PREFERRED EMBODIMENTS

The directional or approximate terms used throughout the specification, such as “front”, “rear”, “left”, “right”, “top”, “bottom”, “inner”, “outer”, “side”, etc., mainly refer to the direction of the accompanying drawings. These directional or approximate terms are used only to assist in describing and understanding various embodiments of the present invention and are not intended to limit the present invention.

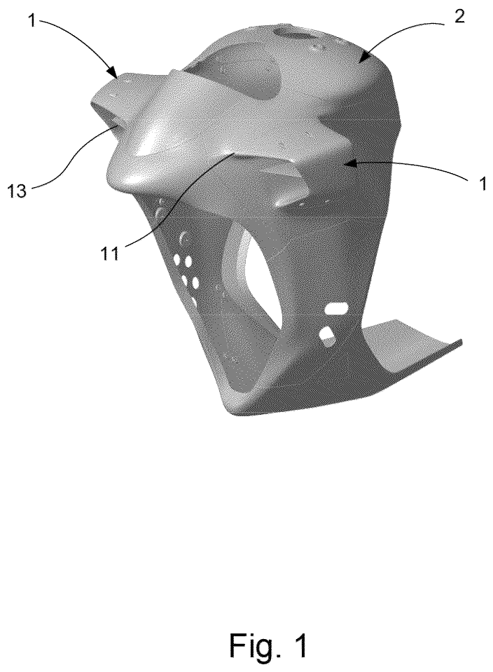

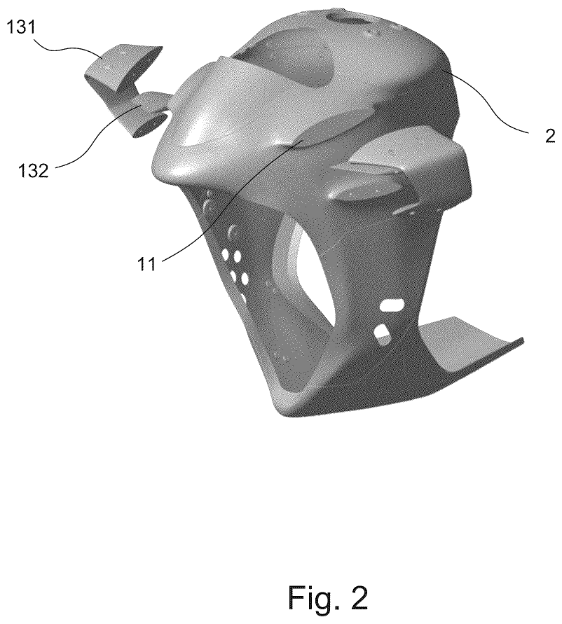

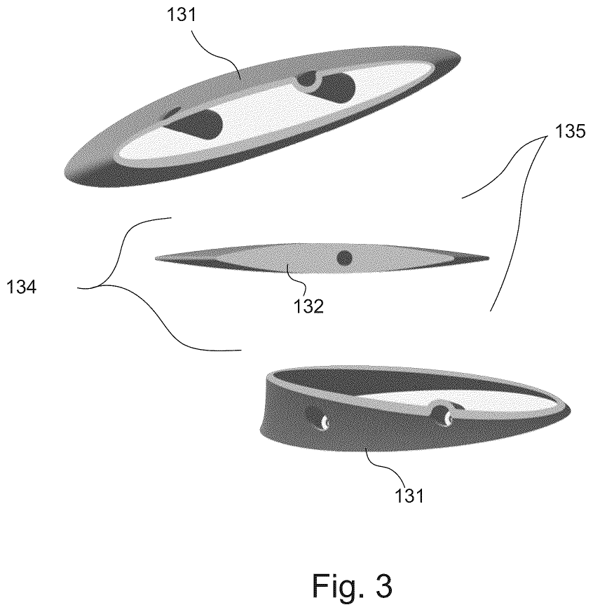

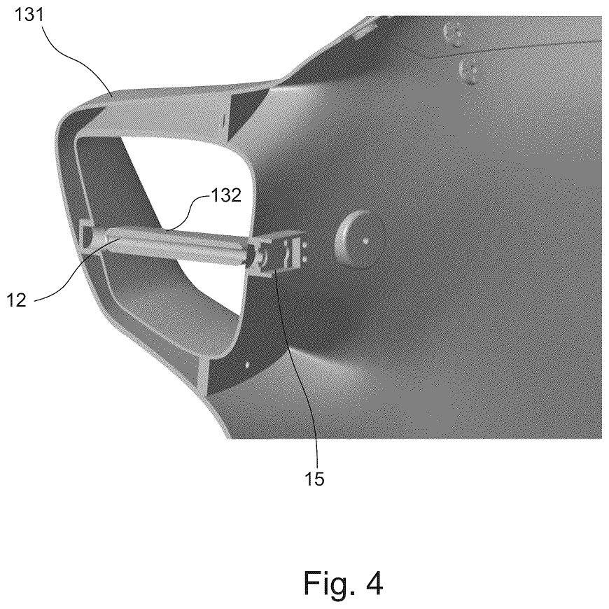

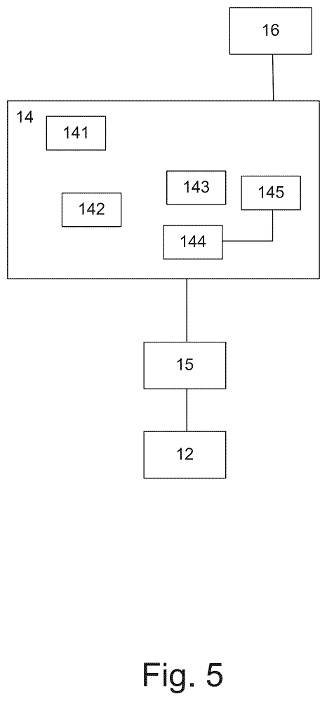

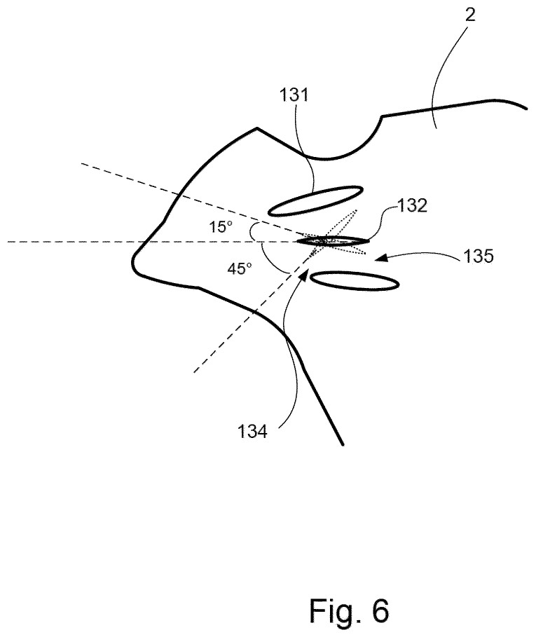

FIG. 1 is a perspective view of the variable-angle vehicle fixed wind wing structure (1) of the present invention installed on the motorcycle shell. FIG. 2 is a partially exploded perspective view of FIG. 1. FIG. 3 is a sectional view of the variable-angle vehicle fixed wind wing structure of the present invention. FIG. 4 is another sectional view of the variable-angle vehicle fixed wind wing structure of the present invention. FIG. 5 is a partial modular block diagram of the variable-angle vehicle fixed wind wing structure of the present invention. FIG. 6 is a schematic diagram showing the angle change of the fixed wind wing structure of the present invention.

As shown in FIGS. 1-6, the variable-angle vehicle fixed wind wing structure (1) of the present invention mainly includes a fixed seat (11), a rotating shaft (12), a fixed wind wing mechanism (13), a control device (14), a driving unit (15), and a vehicle motion sensor (16). The fixed seat (11) is used to be installed on the vehicle (2), and the rotating shaft (12) is disposed on the fixed seat (11).

Furthermore, in the present invention, the fixed wind wing mechanism (13) includes a support frame (131) and a fixed wing (132). The support frame (131) and the fixed wing (132) are spaced apart to form an air inlet (134) and an air outlet (135), and the rotating shaft is installed on the support frame (131) and connected to the fixed wing (132). Additionally, the control device (14) is installed on the vehicle (2) and electrically connected to a driving unit (15), which is coupled to the rotating shaft (12) and connected to the fixed wind wing mechanism (13). By operating the driving unit (15), the rotating shaft (12) can be rotated to control the flipping of the fixed wing (132), thereby adjusting the flipping angle of the fixed wing (132) and changing the distance between the fixed wing (132) and the support frame (131), as well as the air intake and air outflow through the air inlet (134) and air outlet (135), respectively.

Furthermore, in the present invention, as air flows through the air inlet (134), fixed wind wing (132), and air outlet (135), a downforce is generated and provided to the vehicle depending on the flip angle and cross-sectional shape of the fixed wind wing (132). The control device (14) can control the flip angle of the fixed wind wing (132), and adjusts the flip angle of the fixed wind wing (132) automatically and in real-time according to the driving posture and speed of the vehicle (2).

In this embodiment, as shown in the drawings, the support frame (131) is a square-shape support frame, and the rotating shaft (12) and a rotating support shaft (133) are correspondingly arranged on two corresponding sides of the square-shape support frame. The two ends of the fixed-wing (132) are respectively connected to the rotating shaft (12) and the rotating support shaft (133) and traverse the square-shape support frame to form a rectangular structure with a horizontal bar. In addition, the square-shape support frame and the fixed-wing (132) each form two air inlets (134) and two air outlets (135). By changing the angle of the fixed-wing (132), the airflow speed of the two air inlets and two air outlets can be affected, thereby generating an overall aerodynamic effect and air downforce for the support frame (131) and the fixed-wing (132).

It should be noted that in the present invention, the type of the support frame (131) can also be applied to an equals sign-shaped support frame. In the structure of the equals sign-shaped support frame, the rotating shaft (12) is set in the middle of the two corresponding sides of the equals sign-shaped support frame, and one end of the fixed wing (132) is connected to the rotating shaft (12) to form a three-tiered horizontal structure in the middle of the equals sign-shaped support frame. Furthermore, the equals sign-shaped support frame and the fixed wing (132) respectively form two air inlets (134) and two air outlets (135). By changing the angle of the fixed wing (132), the airflow velocity of the two air inlets and two air outlets can be affected, thereby generating an overall aerodynamic effect and air downforce for the entire support frame (131) and fixed wing (132).

According to the description of the second type of support frame structure mentioned above, it is important to emphasize that the core technology and claims of the present invention can be applied to various types of support frames, not limited to square-shape or equals sign-shaped support frame structures. The length, position adjustment, and other variations between the support frame and the fixed wind wing should also belong to the scope of the core technology of the present invention.

In addition, in the technology of the present invention, the upper and lower cross-sections of the support frame (131) are also presented in a wing-shaped structure, thereby allowing the support frame (131) and the fixed wind wing (132) to produce a whole wind field effect. With the design of the upper and lower edges of the support frame (131) together with the fixed wind wing (132), the fixed wind wing mechanism (13) of the present invention has a total of three wings. When the airflow passes through the fixed wind wing mechanism (13), a whole wind field effect can be generated by the structure of the three wings. In addition, by the design of this structure, when the angle of the variable-angle fixed wind wing rotates, it not only changes the wind field that the airflow passes through the fixed wind wing (132) structure but also affects the wind field passing through the upper and lower two support frame wings. This makes the wind field effect produced by the fixed wind wing mechanism (13) of the present invention different from that of traditional single-piece fixed wind wing structures.

In addition, in the present invention, the vehicle motion sensor (including speed/attitude) (16) is installed on the vehicle (2), and the vehicle motion sensor (16) can sense the traveling speed, leaning angle, headwind, and tailwind of the vehicle (2), and transmit the sensing results to the control device (14). The control device (14) includes a computing unit (141), a comparison unit (142), and a storage unit (143). When the vehicle motion sensor (16) transmits the sensing results to the control device (14), the computing unit (141) integrates and calculates the traveling speed, leaning angle, headwind, and tailwind parameters, and obtains a calculation result. The comparison unit (142) compares the calculation result with the adjustment parameters recorded in the storage unit, and then controls the flipping angle of the fixed wing (132) according to the closest adjustment parameter.

Furthermore, the control device (14) further includes a control unit (144) and a communication interface (145). The control unit (144) is electrically connected to the communication interface (145). The control unit (144) adjusts the rotation angle of the fixed wing (132) by the driving unit (15), and the communication interface (145) receives the vehicle attitude signal from the vehicle motion sensor (16). The communication interface (145) can receive signals from other electronic control systems of the vehicle (2) and adjust the flipping angle of the fixed wing (132) proactively. Moreover, the communication interface (145) can transmit the flipping angle of the fixed wing (132) to the electronic control system of the vehicle (2) to provide angle information of the fixed wing (132) to the driver of the vehicle (2).

In more detail, in the present invention, the material of the fixed wind wing (132) and the fixed seat (11) is not limited to any particular material or casting form. Preferably, from a competitive perspective, the material of the fixed wind wing (132) and the fixed seat (11) can be selected as lightweight materials such as carbon fiber or alloys. In addition, the side profile shape of the fixed wind wing (132) is an airfoil structure, and the upper and lower side profile shapes of the fixed seat (11) are also airfoil structures. The front opening (air inlet) area of the fixed seat is smaller than the rear opening (air outlet) area. Moreover, the fixed wind wing (132) can be rotated between an upward angle of 0 to 45 degrees and a downward angle of 0 to 90 degrees between the upper and lower sides of the fixed seat to achieve the best angle adjustment for the wind field effect.

In addition, in the present invention, the vehicle is a motorcycle, and the motorcycle is equipped with two sets of variable-angle vehicle fixed wind wing structures, which are installed on both sides of the front of the motorcycle shell. Furthermore, the driving unit is a motor device, and the control device (14) can be integrated and linked in the motorcycle's electronic control module, thereby displaying the operation status of the fixed wind wing on the motorcycle dashboard and providing related information to the rider. Meanwhile, the rider can also adjust the default flipping angle of the fixed wind wing in different vehicle modes through active control.

More specifically, in this embodiment, when the vehicle speed is high, the variable-angle vehicle fixed wind wing structure of the present invention will cause the fixed wind wing mechanism (13) to flip to a larger angle, thereby increasing the downforce provided by the entire fixed wind wing structure, improving the friction between the vehicle (tire) and the ground and allowing for higher energy conversion of the vehicle power output, avoiding tire slipping or suspension due to insufficient friction. Conversely, when the vehicle speed is low, the variable-angle vehicle fixed wind wing structure of the present invention will cause the fixed wind wing mechanism (13) to flip to a smaller angle, thereby reducing the downforce provided by the entire fixed wind wing structure.

Therefore, the variable-angle vehicle fixed wind wing structure (1) provided by the present invention can achieve the following advantages and improve the deficiencies of the prior art:
Variable-angle wind wing: Compared to a fixed wind wing, the present invention provides a variable-angle wind wing that can automatically switch angles according to the vehicle speed, helping to generate a downforce that is more suitable for the current vehicle speed, improving maneuverability and driving safety.
Automatic angle adjustment: Since the present invention provides a structure with automatic angle adjustment, the vehicle owner does not need to adjust it manually, reducing the operational burden and improving the convenience of use.

The above description is only an embodiment of the present invention and is not intended to limit the scope of the patent. Therefore, any simple modifications and equivalent structural changes made using the contents of the present invention specification and drawings are included within the scope of the present invention patent.

What is claimed is:

1. A variable-angle vehicle fixed wind wing structure (1), comprising:
a fixed seat (11) for installation on a vehicle (2);
a rotating shaft (12) set on the fixed seat (11);
a fixed wind wing mechanism (13) including a support frame (131) and a fixed-wing (132), wherein a distance is maintained between the support frame (131) and the fixed-wing (132) to form at least one air inlet (134) and at least one air outlet (135), and the rotating shaft is installed on the support frame (131) and connected to the fixed-wing (132); and
a control device (14) installed on the vehicle (2) and electrically connected to a driving unit (15);
wherein the driving unit (15) is coupled to the rotating shaft (12) and connected to the fixed wind wing mechanism (13), and the rotation of the rotating shaft (12) is controlled by the driving unit (15) to flip the fixed-wing (132), thereby adjusting the flipping angle of the fixed-wing (132) and changing the distance between the fixed-wing (132) and the support frame (131) as well as the inflow and outflow through the air inlet (134) and the air outlet (135);
wherein, during the process of air flowing through the air inlet (134), the fixed-wing (132), and the air outlet (135), pressure is generated and provided to the vehicle according to the flipping angle and cross-sectional shape of the fixed-wing (132);
wherein the control device (14) is disposed for controlling the flipping angle of the fixed-wing (132), and adjusts the flipping angle of the fixed-wing (132) automatically and in real-time based on the traveling posture and speed of the vehicle (2).

2. The variable-angle vehicle fixed wind wing structure according to claim 1, wherein the support frame (131) is a square-shape support frame, and the rotating shaft (12) and a rotating support shaft (133) are correspondingly set on two corresponding sides of the square-shape support frame, and the two ends of the fixed-wing (132) are respectively connected to the rotating shaft (12) and the rotating support shaft (133) to form a rectangular structure with a horizontal bar; the upper and lower cross-sectional shapes of the support frame (131) also exhibit a wing-like structure, thereby allowing the support frame (131) and the fixed-wing (132) to generate an integrated wind field effect.

3. The variable-angle vehicle fixed wind wing structure according to claim 2, wherein the mouth-shaped support frame and the fixed wing (132) form two air inlets (134) and two air outlets (135), and by changing the flipping angle of the fixed wing (132), the air flow velocity of the two air inlets and two air outlets can be affected, thereby causing an overall aerodynamic effect and air downforce on the support frame (131) and the fixed wing (132).

4. The variable-angle vehicle fixed wind wing structure according to claim 1, wherein the support frame (131) is a equals sign-shaped support frame, and the rotating shaft (12) is located in the middle of the two corresponding edges of the equals sign-shaped support frame, and one end of the fixed wing (132) is connected to the rotating shaft (12) to form a three-tiered horizontal structure in the middle of the equals sign-shaped support frame; the upper and lower cross-sectional shapes of the support frame (131) also present a wing-shaped structure, thereby allowing the support frame (131) and the fixed wing (132) to generate an overall wind field effect.

5. The variable-angle vehicle fixed wind wing structure according to claim 4, wherein the equal sign shape support frame and the fixed-wing (132) form two air inlets (134) and two air outlets (135) respectively, by changing the flipping angle of the fixed-wing (132), the air flow velocity of the two air inlets and two air outlets can be affected, thereby producing a whole aerodynamic effect and air downforce on the entire support frame (131) and fixed-wing (132).

6. The variable-angle vehicle fixed wind wing structure according to claim 1, further comprising a vehicle motion sensor (16) installed on the vehicle (2), wherein the vehicle motion sensor (16) is disposed for sensing the vehicle's (2) speed, inclination angle, headwind, and tailwind, and transmitting the sensing results to the control device (14).

7. The variable-angle vehicle fixed wind wing structure according to claim 6, wherein the control device (14) comprises a computing unit (141), a comparison unit (142), and a storage unit (143), and when the vehicle motion sensor (16) transmits the sensing result to the control device (14), the computing unit (141) integrates and calculates the vehicle dynamic parameters such as the travel speed, tilt angle, headwind, and tailwind, to obtain a calculation result, and the comparison unit (142) compares the calculation result with the adjustment parameters recorded in the storage unit to control the flip angle of the fixed wind wing (132) based on the closest adjustment parameter.

8. The variable-angle vehicle fixed wind wing structure according to claim 7, further comprising a control unit (144) and a communication interface (145) in the control device (14), and the control unit (144) is electrically connected to the communication interface (145), and the control unit (144) adjusts the rotation angle of the fixed wind wing (132) by driving unit (15), and the communication interface (145) receives the driving motion signals from the vehicle motion sensor (16).

9. The variable-angle vehicle fixed wind wing structure according to claim 8, wherein the communication interface (145) is disposed for receiving signals from other electronic control systems of the vehicle (2) and performing active adjustments of the rotation angle of the fixed wind wing (132).

10. The variable-angle vehicle fixed wind wing structure according to claim 9, wherein the communication interface (145) is disposed for transmitting the rotation angle of the fixed wind wing (132) to the electronic control system of the vehicle (2), thereby providing angle information of the fixed wind wing (132) to the driver of the vehicle (2).
